(19) United States
(12) Patent Application Publication
(10) Pub. No.: US 2023/0180717 A1
(43) Pub. Date: Jun. 15, 2023

(54) HORSE LEG PROTECTOR

(71) Applicant: JONE SHOU INDUSTRIAL CO., LTD., NANTOU COUNTY (TW)

(72) Inventor: Chih Shun CHANG, NANTOU COUNTY (TW)

(21) Appl. No.: 18/080,876

(22) Filed: Dec. 14, 2022

(30) Foreign Application Priority Data
Dec. 15, 2021 (TW) 110214931

(51) Int. Cl. A01K 13/00

(52) U.S. Cl. CPC A01K 13/007

(57) ABSTRACT

A horse leg protector has a protection body. The protection body has an upper half for wrapping a metacarpal bone of a horse leg and a lower half for wrapping a sesamoid bone of the horse leg. At least one slot is formed in the upper half of the protection body and extends horizontally. The slot has two ends that are closed. The upper half of the protection body is partitioned into a first protection segment and a second protection segment by the slot. The second protection segment is bendable relative to the first protection segment for a distance between two opposite side walls of the slot to become larger or smaller.

### FIELD OF THE INVENTION

The present invention relates to a protector, and more particularly to a horse leg protector.

### BACKGROUND OF THE INVENTION

When a horse is running at high speed or jumping, the horse stretches out its front and rear legs in opposite directions. Sometimes when the rear legs lift forward and the front legs do not stretch forward, the rear legs may kick the front legs, causing an injury to the front legs.

In order to solve the aforementioned problem, the horse leg is wrapped with a protector to prevent an injury to the front leg when the front leg is kicked by the rear leg. Taiwan Patent Publication No. M564908 discloses a horse leg protector. The horse leg protector is in the shape of a cylinder extending along the length of the horse leg for wrapping part of the horse leg. However, in order to achieve the purpose of protection, a conventional horse leg protector is generally made of hard materials, such as hard plastics or metal plates, and a soft cushion as a lining is disposed on the inner side of the horse leg protector. Because the horse legs are not straight, the horse will bend its legs for running. When a horse wears a leg protector, if the leg protector is unable to be in close contact with the surface of the horse leg, it will cause discomfort and affect the smoothness of running.

### SUMMARY OF THE INVENTION

The primary object of the present invention is to provide a horse leg protector for wrapping a horse leg. When the horse is running, the horse leg protector is deformable to be in close contact with the horse leg, without affecting running. Under the premise of protecting the horse leg, the horse leg protector can improve the comfort of wearing the horse leg protector.

In order to achieve the foregoing object, the present invention provides a horse leg protector, comprising a first protection segment for wrapping a metacarpal bone of a horse leg and a second protection segment for wrapping the metacarpal bone of the horse leg. The second protection segment is located above the first protection segment and connected to the first protection segment. A first slot is formed between the first protection segment and the second protection segment. The second protection segment is bendable relative to the first protection segment between a first deformation position and a second deformation position. When the second protection segment is in the first deformation position, a distance between two opposite side walls of the first slot becomes larger. When the second protection segment is in the second deformation position, the distance between the two opposite side walls of the first slot becomes smaller.

The first protection segment has a first middle portion. Two opposite sides of the first middle portion extend laterally to form a first left side portion and a first right side portion, respectively. The second protection segment has a second middle portion. Two opposite sides of the second middle portion extend laterally to form a second left side portion and a second right side portion, respectively. The first left side is connected to the second left side. The first right side is connected to the second right side.

The first slot has two ends that are closed and extend horizontally to the second left side portion and the second right side portion, respectively.

A lower protection segment for wrapping a sesamoid bone of the horse leg is located under the first protection segment and connected to the first protection segment. A second slot is formed between the lower protection segment and the first protection segment.

### BRIEF DESCRIPTION OF THE DRAWINGS

FIG. 1 is a planar view of the present invention;

FIG. 2 is a side view of the present invention;

FIG. 3 is a schematic view of the present invention when in use;

FIG. 4 is a partial enlarged view of FIG. 3;

FIG. 5 and FIG. 6 are schematic views illustrating the action of the present invention.

### DETAILED DESCRIPTION OF THE PREFERRED EMBODIMENTS

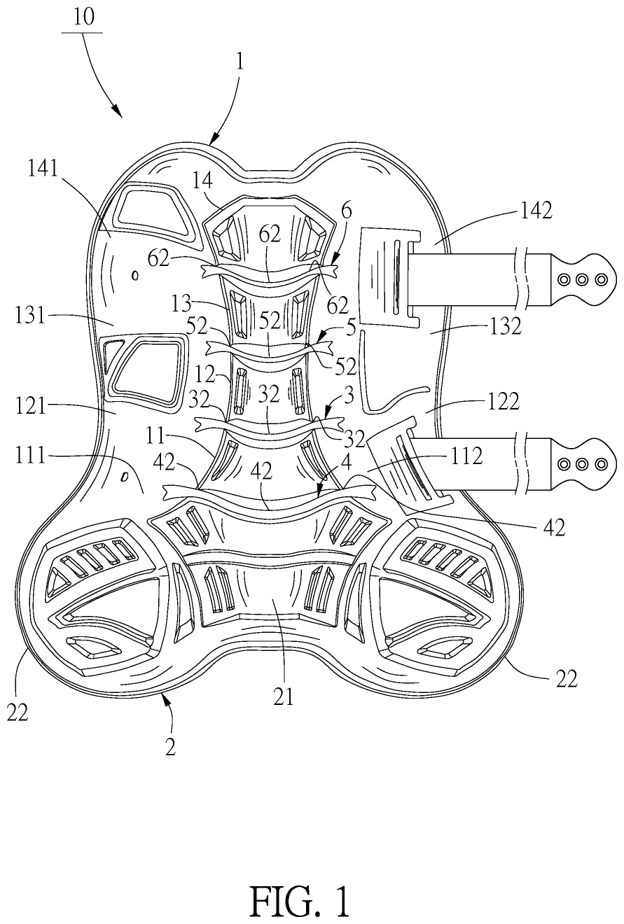

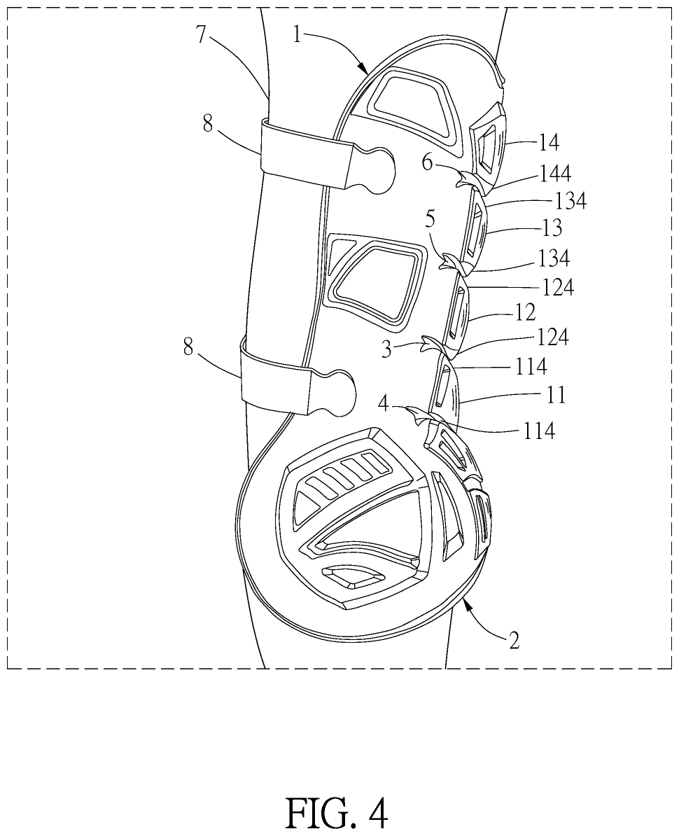

Referring to FIGS. 1 to 6, a horse leg protector provided by the present invention comprises a protection body 10 and at least one slot. The protection body 10 is configured to wrap a horse leg.

The protection body 10 has an upper half 1 for wrapping a metacarpal bone of the horse leg and a lower half 2 located below the upper half 1 for wrapping a sesamoid bone of the horse leg.

The slot is formed in the upper half 1 of the protection body 10 and extend horizontally. The slot has two ends that are closed. The slot is continuously curved between the two ends, and consists of at least two curved sections that are curved in opposite directions. In this embodiment, the number of slots is four. Each slot consists of three curved sections between its two ends. The four slots are defined as a first slot 3, a second slot 4, a third slot 5 and a fourth slot 6. The two ends of each slot are bifurcated to form two corner grooves (31, 41, 51, 61), respectively. The two corner grooves (31, 41, 51, 61) extend obliquely in different directions, so that either end of each slot is in the shape of a dovetail. The width of each slot is proportional to its length.

The upper half 1 of the protection body 10 is partitioned into a first protection segment 11 and a second protection segment 12 above the first protection segment 11 by the first slot 3. The first protection segment 11 has a first middle portion 113. The second protection segment 12 has a second middle portion 123. Two opposite sides of the first middle portion 113 extend laterally to form a first left side portion 111 and a first right side portion 112, respectively. Two opposite sides of the second middle portion 123 extend laterally to form a second left side portion 121 and a second right side portion 122, respectively. The first left side 111 is connected to the second left side 121. The first right side 112 is connected to the second right side 122. Preferably, the first slot 3 consists of three first curved sections 32 between its two ends. The curved direction of at least one of the first curved sections 32 is opposite to that of the other first curved sections 32. The two ends of the first slot 3 extend horizontally to the second left side portion 121 and the second right side portion 122, respectively.

The upper half 1 of the protection body 10 is partitioned into the second protection segment 12 and a third protection segment 13 above the second protection segment 12 by the third slot 5. The third protection segment 13 is connected to the second protection segment 12. The third protection segment 13 has a third middle portion 133. Two opposite sides of the third middle portion 133 extend laterally to form a third left side portion 131 and a third right side portion 132, respectively. The third left side 131 is connected to the second left side 121. The third right side 132 is connected to the second right side 122. Preferably, the third slot 5 consists of three third curved sections 52 between its two ends. The curved direction of at least one of the third curved sections 52 is opposite to that of the other third curved sections 52. The two ends of the third slot 5 extend horizontally to the third left side portion 131 and the third right side portion 132, respectively.

The upper half 1 of the protection body 10 is partitioned into the third protection segment 13 and a fourth protection segment 14 above the third protection segment 13 by the fourth slot 6. The fourth protection segment 14 is connected to the third protection segment 13. The fourth protection segment 14 has a fourth middle portion 143. Two opposite sides of the fourth middle portion 143 extend laterally to form a fourth left side portion 141 and a fourth right side portion 142, respectively. The fourth left side 141 is connected to the third left side 131. The fourth right side 142 is connected to the third right side 132. Preferably, the fourth slot 6 consists of three fourth curved sections 62 between its two ends. The curved direction of at least one of the fourth curved sections 62 is opposite to that of the other fourth curved sections 62. The two ends of the fourth slot 6 extend horizontally to the fourth left side portion 141 and the fourth right side portion 142, respectively.

The lower half 2 includes a lower protection segment 21 corresponding to the sesamoid bone of the horse leg. The lower protection segment 21 is located below the first protection segment 11 and connected to the first protection segment 11. Two sides of the lower protection segment 21 extend outward to form arc-shaped extension portions 22 for wrapping the sesamoid bone of the horse leg, thereby increasing the wrapping area. The width of the outline of the lower protection segment 21 is greater than the width of the outline of each protection segment. The second slot 4 is formed in one side of the first protection segment 11 adjacent to the lower protection segment 21. The second slot 4 consists of three second curved sections 42 between its two ends. The curved direction of at least one of the second curved sections 42 is opposite to that of the other second curved sections 42. The two ends of the second slot 4 extend horizontally to the first left side portion 111 and the first right side portion 112, respectively.

With the above structure, in this embodiment, the protection body 10 is partitioned into a plurality of protection segments by the slots. Through the slots, the protection body 10 is slotted to increase the flexibility of each protection segment relative to the other protection segments.

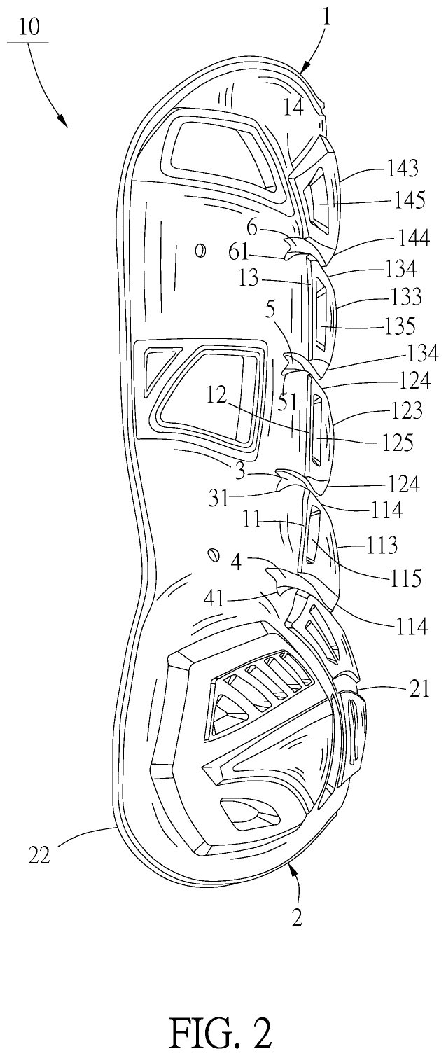

Further, referring to FIG. 2, the center of the first protection segment 11 protrudes outward to form the first middle portion 113, and the center of the second protection segment 12 protrudes outward to form the second middle portion 123. The first middle portion 113 and the second middle portion 123 each have at least one air vent 115, 125 extending vertically, so as to increase the air breathability of the horse leg protector. The first middle portion 113 and the second middle portion 123 each have a slope 114, 124 connected to the side edge of the first slot 3. This prevents the second protection segment 12 and the first protection segment 11 from being obstructed by the corners of the second protection segment 12 and the first protection segment 11 when the horse bends its horse leg 7, so as to increase the degree of bending the second protection segment 12 and the first protection segment 11.

Similarly, the center of the third protection segment 13 protrudes outward to form the third middle portion 133, and the center of the fourth protection segment 14 protrudes outward to form the fourth middle portion 143. The third middle portion 133 and the fourth middle portion 143 each have at least one air vent 135, 145 extending vertically. The third middle portion 133 and the fourth middle portion 143 each have a slope 134, 144 connected to the side edge of the adjacent slot, having the same function as the first protection segment 11 and the second protection segment 12.

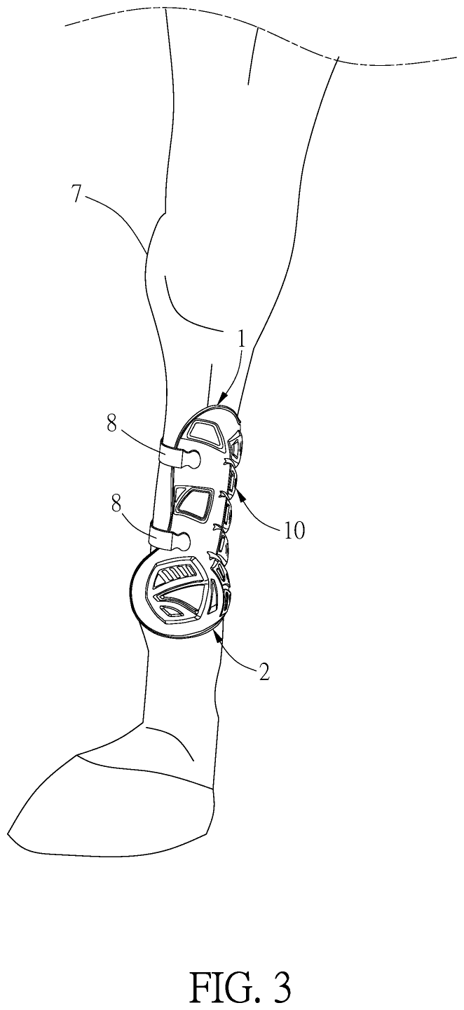

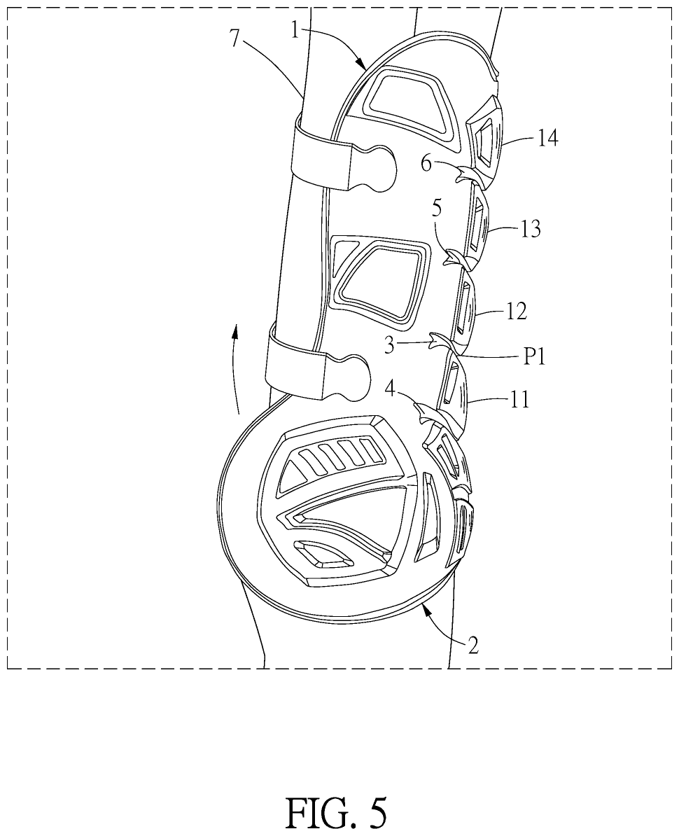

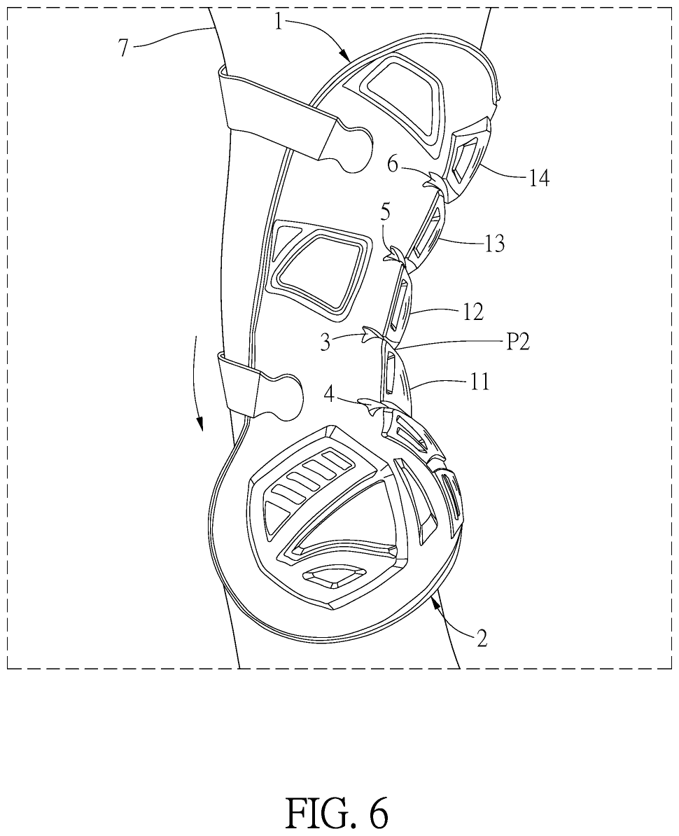

FIGS. 3 to 6 are schematic views of the horse leg protector provided by the present invention in actual use. The horse leg protector is tied on the rear of the horse leg 7 with a strap 8, playing a protective role. As shown in FIGS. 3 to 6, the front leg of a horse is taken as an example. When the horse leg protector is tied on the rear of the horse leg 7 with the strap 8, the second protection segment 12 is bendable relative to the first protection segment 11 between a first deformation position P1 when the horse leg 7 is straightened and a second deformation position P2 when the horse leg 7 is bent. As shown in FIG. 5, when the horse is running, the horse leg 7 is stretched forward to the position where the second protection segment 12 wraps the horse leg 7 and when the second protection segment 12 is in the first deformation position P1, the two opposite side walls of the first slot 3 along its long axis direction are far away from each other so that the distance between the two opposite side walls becomes larger. The first protection segment 11 and the second protection segment 12 are still in close contact with the surface of the horse leg 7, respectively. As shown in FIG. 6, when the horse is running, the horse leg 7 is bent backward to the position where the second protection segment 12 wraps the horse leg 7 and when the second protection segment 12 is in the second deformation position P2, the two opposite side walls of the first slot 3 along its long axis direction are close to each other so that the distance between the two opposite side walls becomes smaller. The first protection segment 11 and the second protection segment 12 are still in close contact with the surface of the horse leg 7, respectively.

In addition, when the horse runs and changes the posture of the horse leg 7 to move to the position where each protection segment wraps the horse leg 7, through the distance between the side walls of the adjacent slot, each protection segment can move relative to other protection segments in response to changes in the posture of the horse leg to be in close contact with the surface of the horse leg 7. Accordingly, through the second slot 4, the third slot 5 and the fourth slot 6, all the adjacent protection segments can be in close contact with the surface of the horse leg 7.

It should be noted that because the horse leg 7 is substantially cylindrical, the protection body 10 wraps the surface of the horse leg 7 in an arc. Compared with the fact that the straight slots of a conventional horse leg protector cannot be completely closed when the conventional horse leg protector wraps the horse leg, each slot of the present invention is curved so that the two opposite side walls of the slot can be completely close to each other to close the slot. In this way, the surface of the horse leg 7 won't be exposed and the horse hoof won't kick the surface of the horse leg 7, so as to protect the horse leg 7 from being injured.

In addition, the two corner grooves (31, 41, 51, 61) of each slot are in the shape of a dovetail, so as to reduce the wall thickness of either end of the slot. Thus, the two opposite sides of the slot can be close to each other easily, so as to close the slot.

With the above structure of the present invention, the protection body 10 is partitioned into a plurality of protection segments by the four slots. Through the slots, the protection body 10 is slotted to increase the flexibility of each protection segment relative to the other protection segments. When the horse is running, the shape of the horse leg protector changes in response to changes in the posture of the horse leg so that the protection body 10 is always in close contact with the surface of the horse leg 7. In addition to protecting the horse leg 7, the horse leg protector can make the horse feel comfortable, without affecting running. Under the premise of protecting the horse leg 7, the horse leg protector can improve the comfort of wearing the horse leg protector.

What is claimed is:

1. A horse leg protector, comprising:
a first protection segment for wrapping a metacarpal bone of a horse leg;
a second protection segment for wrapping the metacarpal bone of the horse leg, the second protection segment being located above the first protection segment and connected to the first protection segment, a first slot being formed between the first protection segment and the second protection segment, the second protection segment being bendable relative to the first protection segment between a first deformation position and a second deformation position;
wherein when the second protection segment is in the first deformation position, a distance between two opposite side walls of the first slot becomes larger; when the second protection segment is in the second deformation position, the distance between the two opposite side walls of the first slot becomes smaller;
wherein the first protection segment has a first middle portion, two opposite sides of the first middle portion extend laterally to form a first left side portion and a first right side portion respectively, the second protection segment has a second middle portion, two opposite sides of the second middle portion extend laterally to form a second left side portion and a second right side portion respectively, the first left side is connected to the second left side, and the first right side is connected to the second right side;
wherein the first slot has two ends that are closed and extend horizontally to the second left side portion and the second right side portion, respectively;
wherein a lower protection segment for wrapping a sesamoid bone of the horse leg is located under the first protection segment and connected to the first protection segment, and a second slot is formed between the lower protection segment and the first protection segment.

2. The horse leg protector as claimed in claim 1, wherein each of the first slot and the second slot is continuously curved between its two ends.

3. The horse leg protector as claimed in claim 2, wherein each of the first slot and the second slot consists of at least two curved sections that are curved in opposite directions.

4. The horse leg protector as claimed in claim 1, wherein the two ends of each of the first slot and the second slot are bifurcated to form two corner grooves respectively, and the two corner grooves extend obliquely in different directions so that the ends of the first slot and the second slot are each in the shape of a dovetail.

5. The horse leg protector as claimed in claim 1, wherein a center of the first protection segment protrudes outward to form the first middle portion, a center of the second protection segment protrudes outward to form the second middle portion, the first middle portion and the second middle portion each have a slope connected to a side edge of the first slot.

6. The horse leg protector as claimed in claim 1, wherein the first middle portion and the second middle portion each have at least one air vent extending vertically.

7. The horse leg protector as claimed in claim 1, wherein two sides of the lower protection segment extend outward to form arc-shaped extension portions for wrapping the sesamoid bone of the horse leg, and a width of an outline of the lower protection segment is greater than a width of an outline of each of the first protection segment and the second protection segment.

8. The horse leg protector as claimed in claim 1, wherein the first slot and the second slot each have a width that is proportional to its length.

9. The horse leg protector as claimed in claim 1, further comprising a third protection segment located above the second protection segment, the third protection segment being connected to the second protection segment, a third slot being formed between the third protection segment and the second protection segment.

10. The horse leg protector as claimed in claim 9, wherein two opposite sides of the third protection segment extend laterally to form a third left side portion and a third right side portion respectively, the third left side is connected to the second left side, and the third right side is connected to the second right side.

11. A horse leg protector, comprising:
a protection body, having an upper half for wrapping a metacarpal bone of a horse leg and a lower half located below the upper half for wrapping a sesamoid bone of the horse leg;
at least one slot, formed in the upper half of the protection body and extending horizontally, the slot having two ends that are closed, the upper half of the protection body being partitioned into a first protection segment and a second protection segment above the first protection segment by the slot, the second protection segment being bendable relative to the first protection segment between a first deformation position and a second deformation position;
wherein when the second protection segment is in the first deformation position, a distance between two opposite side walls of the slot becomes larger; when the second protection segment is in the second deformation position, the distance between the two opposite side walls of the slot becomes smaller.

12. The horse leg protector as claimed in claim 11, wherein the slot is continuously curved between its two ends.

13. The horse leg protector as claimed in claim 12, wherein the slot consists of at least two curved sections that are curved in opposite directions.

14. The horse leg protector as claimed in claim 11, wherein the two ends of the slot are bifurcated to form two corner grooves respectively, and the two corner grooves extend obliquely in different directions so that the ends of the slot are each in the shape of a dovetail.

15. The horse leg protector as claimed in claim 11, wherein a center of the first protection segment protrudes outward to form a first middle portion, a center of the second protection segment protrudes outward to form a second middle portion, and the first middle portion and the second middle portion each have a slope connected to a side edge of the slot.

16. The horse leg protector as claimed in claim 11, wherein two sides of the lower half extend outward to form arc-shaped extension portions for wrapping the sesamoid bone of the horse leg, and a width of an outline of the lower half is greater than a width of an outline of each of the first protection segment and the second protection segment.

17. The horse leg protector as claimed in claim 11, wherein the slot has a width that is proportional to its length.
